(19) United States
(12) Patent Application Publication
(10) Pub. No.: US 2024/0118169 A1
(43) Pub. Date: Apr. 11, 2024

(54) VIBRATION ANALYSIS APPARATUS AND VIBRATION ANALYSIS SYSTEM

(71) Applicant: NTN Corporation, Osaka (JP)

(72) Inventor: So YAMAGUCHI, Kuwana-shi, Mie (JP)

(21) Appl. No.: 18/263,822

(22) PCT Filed: Feb. 3, 2022
(86) PCT No.: PCT/JP2022/004280

§ 371 Date: Aug. 1, 2023

(30) Foreign Application Priority Data
Feb. 8, 2021 (JP) 2021-017899

(51) Int. Cl. G01M 13/045

(52) U.S. Cl. CPC G01M 13/045

(57) ABSTRACT

A vibration analysis apparatus diagnoses a machine state based on vibration detected by a measurement instrument. A setting unit sets a diagnosis target, a rotation speed, and a determination criterion value. A communication unit communicates with the measurement instrument to transmit a trigger to start measurement of vibration to the measurement instrument or to receive data on a vibration waveform from the measurement instrument. A condition determination unit determines a diagnosis condition based on information on the diagnosis target. An analyzer subjects data inputted from the measurement instrument to frequency analysis. An abnormality determination unit makes determination as to an abnormality of the diagnosis target based on the determination criterion value. Thus, the vibration analysis apparatus and a vibration analysis system capable of vibration analysis with certain accuracy being maintained regardless a skill level of a user can be provided.

### TECHNICAL FIELD

The present disclosure relates to a vibration analysis apparatus and a vibration analysis system.

### BACKGROUND ART

A vibration analysis apparatus that measures vibration produced in a rotating body and diagnoses a failure or the like has been known. For example, Japanese Patent Laying-Open No 2016-61752 (PTL 1) discloses a diagnosis apparatus that sets as appropriate a bandwidth of a frequency filter in accordance with a condition of set-up of a rotating body to be diagnosed and analyzes vibration. Japanese Patent Laying-Open No. 2016-24007 (PTL 2) discloses a technique to determine whether or not an abnormality has occurred in an inner ring, an outer ring, a rolling element, a retainer, or the like with a rolling bearing being adopted as a diagnosis target and to show a result of determination with text or signs on a portable information terminal. Japanese Patent Laying-Open No. 2017-219469 (PTL 3) discloses a state monitoring apparatus that determines whether or not an abnormality has occurred based on whether or not a bearing damage frequency and a peak of an envelope spectrum are equal to each other. This state monitoring apparatus divides a vibration waveform with the use of a plurality of frequency filters and diagnoses a degree of damage of a part to be diagnosed based on an effective value calculated for each frequency band.

### CITATION LIST

### Patent Literature

PTL 1: Japanese Patent Laying-Open No. 2016-61752
PTL 2: Japanese Patent Laying-Open No. 2016-24007
PTL 3: Japanese Patent Laying-Open No. 2017-219469

### SUMMARY OF INVENTION

### Technical Problem

A simplified vibration analysis apparatus that measures vibration of a rotating body such as a bearing or a shaft and determines whether or not an abnormality has occurred for the purpose of maintenance of various apparatuses is convenient for a worker.

Such a simplified vibration analysis apparatus is simple in construction and easy to introduce. Therefore, since vibration analysis is readily introduced, a user who uses the simplified vibration analysis apparatus is often inexperienced in vibration analysis. In measurement of vibration, in general, a graph of a frequency analysis result (frequency spectrum) is shown, which is graphical representation of an acceleration for each frequency resulting from frequency analysis of a signal from an acceleration sensor. Without experiences in vibration analysis, it is difficult to know a health state of the rotating body based on a result of vibration analysis. For accurate determination as to an abnormality in a bearing and a shaft, vibration data obtained under an appropriate measurement condition should be subjected to appropriate signal processing and then to frequency analysis. A beginner of vibration analysis, however, is unable to set an appropriate measurement condition or signal processing as such. Therefore, the beginner of vibration analysis may make inappropriate setting for determination as to an abnormality of a machine and may overlook a sign which could be sensed as an abnormality under appropriate setting. The beginner may also erroneously make determination as being normal in spite of an exhibited sign of abnormality.

In a conventional vibration analysis apparatus, regardless of the number of rotations and a condition for set-up of a diagnosis target, a measurement time period, a sampling frequency, or a bandwidth of a frequency filter is fixed, or can freely be selected by a user. When a degree of freedom is higher, however, optimal setting should accordingly be considered, and the user is required to have knowledge about vibration analysis.

In order to diagnose a health state of a bearing based on vibration, in general, whether or not a peak that appears in an envelope spectrum is derived from vibration produced in the bearing is checked. Though a method of simply converting a result of determination into a numerical value or a sign and showing the result is available, it is difficult to find on which peak of a spectrum determination is based. Therefore, it is difficult to evaluate consistency between the spectrum and the result of determination.

An object of the present disclosure is to provide a vibration analysis apparatus and a vibration analysis system capable of vibration analysis with certain accuracy being maintained, regardless of a skill level of a user.

### Solution to Problem

The present disclosure relates to a vibration analysis apparatus that diagnoses a machine state based on detected vibration. The vibration analysis apparatus includes a setting unit that sets a diagnosis target, a rotation speed, and a determination criterion value, a condition determination unit that determines a diagnosis condition based on information on the diagnosis target, an analyzer that subjects inputted data to frequency analysis, and an abnormality determination unit that makes determination as to an abnormality of the diagnosis target based on the determination criterion value.

In another aspect, the present disclosure is directed to a vibration analysis system including a measurement instrument that measures vibration of a diagnosis target and the vibration analysis apparatus described above. The vibration analysis apparatus is implemented by application software that runs on a portable information terminal.

### Advantageous Effects of Invention

According to a vibration measurement apparatus in the present disclosure, an appropriate measurement condition and signal processing are semiautomatically set based on a part of a diagnosis target and the number of rotations. A health state of a rotating body that can be known from a result obtained by vibration measurement is clearly shown. Therefore, even a beginner of vibration analysis can conduct vibration analysis with certain accuracy being maintained.

### BRIEF DESCRIPTION OF DRAWINGS

FIG. 1 is a diagram showing a configuration of a vibration analysis system in the present embodiment.

FIG. 2 is a block diagram showing a configuration of a measurement instrument 2.

FIG. 3 is a functional block diagram of a function performed by application software in a portable information terminal 1.

FIG. 4 is a flowchart for illustrating measurement processing in measurement instrument 2.

FIG. 5 is a flowchart for illustrating an operation of a vibration analysis apparatus implemented by application software for vibration analysis executed in portable information terminal 1.

FIG. 6 is a flowchart showing details of processing for setting a measurement condition in step S14.

FIG. 7 is a diagram showing diagnosis conditions corresponding to a low speed, an intermediate speed, and a high speed.

FIG. 8 is a flowchart of a subroutine (condition determination A) for determining a diagnosis condition when a damage of a bearing or a gear is to be diagnosed.

FIG. 9 is a flowchart of a subroutine (condition determination B) for determining a diagnosis condition when mechanical vibration derived from defective assembly or the like is to be diagnosed.

FIG. 10 is a flowchart of a subroutine (condition determination B) for determining a diagnosis condition in a modification to FIG. 9 in consideration also of a damage of the bearing or the gear.

FIG. 11 is a diagram showing an exemplary screen for setting a measurement condition or the like shown on a display 14.

FIG. 12 is a diagram showing a mathematical expression of a bearing characteristic frequency (BPFO, BPFI, and BSF).

FIG. 13 is a diagram showing exemplary representation of a frequency spectrum shown on display 14.

FIG. 14 is a diagram showing exemplary representation of an envelope spectrum shown on display 14.

FIG. 15 is a diagram showing an exemplary analysis report outputted from portable information terminal 1.

FIG. 16 is a diagram showing a modification of the vibration analysis system.

### DESCRIPTION OF EMBODIMENTS

An embodiment of the present disclosure will be described below with reference to the drawings. The same or corresponding elements in the drawings below have the same reference characters allotted and description thereof will not be repeated.

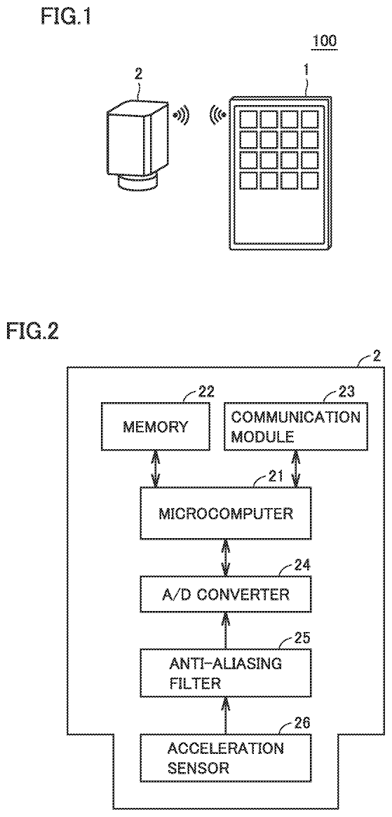

FIG. 1 is a diagram showing a configuration of a vibration analysis system in the present embodiment. A vibration analysis system 100 shown in FIG. 1 includes a measurement instrument 2 that measures vibration of a diagnosis target and a vibration analysis apparatus. This vibration analysis apparatus is implemented by application software that runs on a portable information terminal 1.

Portable information terminal 1 and measurement instrument 2 are configured to wirelessly communicate with each other.

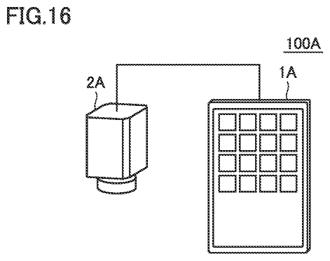

As shown in FIG. 16 later, a portable information terminal 1A and a measurement instrument 2A may be configured to communicate with each other through a wire.

FIG. 2 is a block diagram showing a configuration of measurement instrument 2. Measurement instrument 2 in FIG. 2 includes a microcomputer 21, a memory 22, a communication module 23, an A/D converter 24, an anti-aliasing filter 25, and an acceleration sensor 26.

Measurement instrument 2 is provided in rotating equipment and measures vibration derived from at least one of a bearing, a gear, and a rotation shaft which are diagnosis targets included in the rotating equipment. Acceleration sensor 26 detects vibration as an acceleration signal. A/D converter 24 converts the acceleration signal indicating an acceleration detected by acceleration sensor 26 into a digital signal. Anti-aliasing filter 25 restricts the acceleration signal to a band corresponding to a sampling frequency of A/D converter 24. Microcomputer 21 causes a digital signal representing vibration waveforms over a certain time period to be stored in memory 22, and when microcomputer 21 can communicate with portable information terminal 1, it reads the vibration waveforms from memory 22 and transmits the vibration waveforms to portable information terminal 1 through communication module 23.

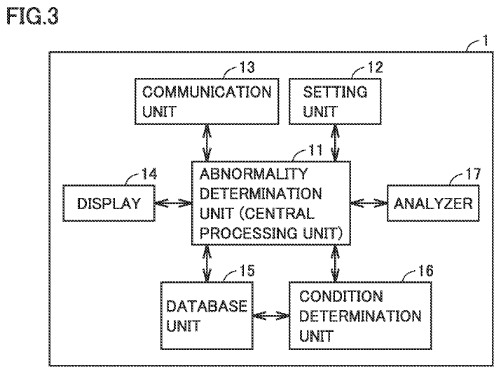

FIG. 3 is a functional block diagram of a function performed by application software in portable information terminal 1.

As application software is installed in portable information terminal 1 shown in FIG. 3, it functions as the vibration analysis apparatus. Portable information terminal 1 is also expressed as vibration analysis apparatus 1 below. Vibration analysis apparatus 1 includes an abnormality determination unit 11, a setting unit 12, a communication unit 13, a display 14, a database unit 15, a condition determination unit 16, and an analyzer 17.

Vibration analysis apparatus 1 diagnoses a machine state based on vibration detected by measurement instrument 2. Setting unit 12 sets a diagnosis target, a rotation speed, and a determination criterion value. Communication unit 13 communicates with measurement instrument 2 to transmit a trigger to start measurement of vibration to measurement instrument 2 or to receive data on a vibration waveform from measurement instrument 2. Condition determination unit 16 determines a diagnosis condition based on information on the diagnosis target. Analyzer 17 subjects data inputted from measurement instrument 2 to frequency analysis. Abnormality determination unit 11 makes determination as to an abnormality of the diagnosis target based on the determination criterion value. Abnormality determination unit 11 is implemented, for example, by a central processing unit (CPU) that executes application software.

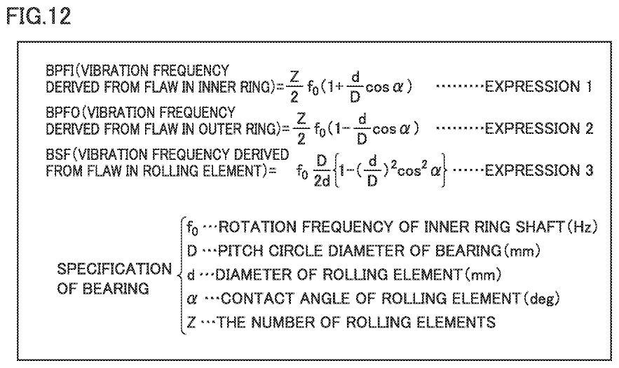

In database unit 15, a parameter for abnormality determination unit 11 to identify a damaged part of the diagnosis target is stored. For example, this parameter includes a rotation speed of the bearing. In this parameter, a coefficient in a mathematical expression (which will be shown in FIG. 12 later) for calculating based on a specification of the bearing or the rotation speed, a vibration frequency (BPFI) derived from a flaw in an inner ring of the bearing, a vibration frequency (BPFO) derived from a flaw in an outer ring of the bearing, and a vibration frequency (BSF) derived from a flaw in a rolling element of the bearing is stored.

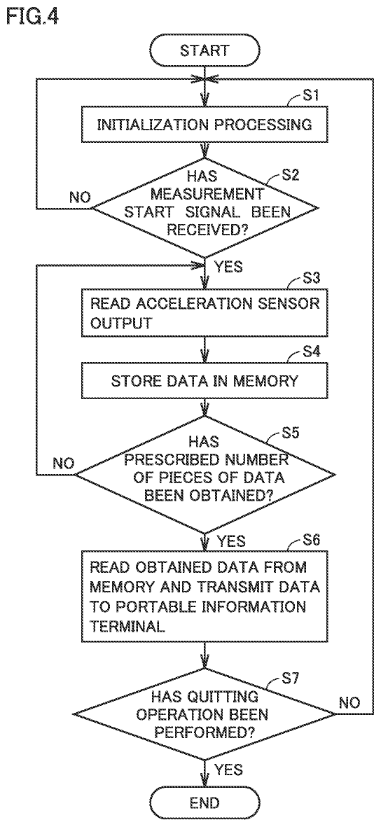

FIG. 4 is a flowchart for illustrating measurement processing in measurement instrument 2. Measurement processing will be described with reference to FIGS. 2 and 4.

In step S1, initialization processing is performed.

In step S2, microcomputer 21 determines whether or not it has received a measurement start signal, and when it has not received the measurement start signal, the process returns to step S1. When microcomputer 21 has received the measurement start signal (YES in S2), in step S3, it reads an output signal from acceleration sensor 26 through A/D converter 24, and causes data converted to a digital signal to be stored in memory 22.

In step S5, microcomputer 21 determines whether or not it has obtained a prescribed number of pieces of data. When the number of pieces of obtained data has not reached the prescribed number (NO in S5), the process returns to step S3 and microcomputer 21 continues to obtain data.

When the number of pieces of obtained data has reached the prescribed number (YES in S5), in step S6, microcomputer 21 reads the obtained data from memory 22 and transmits the data to portable information terminal 1. In step S7, microcomputer 21 determines whether or not an operation to quit measurement has been performed.

When the operation to quit measurement has not been performed (NO in S7), microcomputer 21 performs again processing from step S1. When the operation to quit measurement has been performed (YES in S7), microcomputer 21 quits processing for measurement by measurement instrument 2.

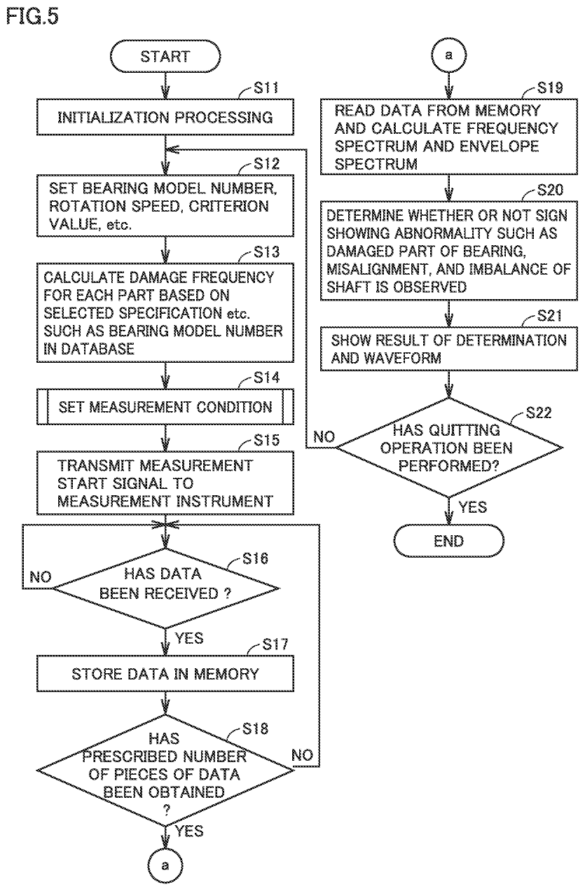

FIG. 5 is a flowchart for illustrating an operation of the vibration analysis apparatus implemented by application software for vibration analysis executed in portable information terminal 1.

An operation of the vibration analysis apparatus will be described with reference to FIGS. 3 and 5. Initially, in step S11, initialization processing is performed. In step S12, setting unit 12 sets a bearing model number, a rotation speed, a criterion value, or the like based on an operation by a user. At this time, the user inputs on the application software, the rotation speed of the diagnosis target, an internal specification of the bearing, and the criterion value (threshold value).

In step S13, abnormality determination unit 11 reads the selected specification such as the bearing model number from database unit 15 and calculates a damage frequency for each part of an apparatus of interest based on the read specification. In step S14, abnormality determination unit 11 performs processing for setting a measurement condition.

Simplified vibration analysis apparatus 1 described in the present embodiment performs in the portable information terminal, processing for storing and calculating measured vibration data.

At this time, a capacity of data is in proportion to a data length calculated from a product of a sampling frequency and a measurement time period. In an example where the sampling frequency and the measurement time period can freely be set, values of the sampling frequency and the measurement time period are set based on a rotation speed of a rotating body to be diagnosed and a necessary frequency band. As long as the portable information terminal is used, however, setting in consideration of restriction of a data processing speed and a data storage capacity should be made, and it is difficult for the beginner of vibration analysis to make this setting.

In the present embodiment, a data length of measurement data is fixed to a numerical value in consideration of restriction of the data processing speed and the data storage capacity in advance.

A plurality of diagnosis conditions among which a sampling frequency and a measurement time period are adjusted such that the number of pieces of data is equal are stored in advance in the application software. In the present embodiment, three types of a low speed, an intermediate speed, and a high speed are stored.

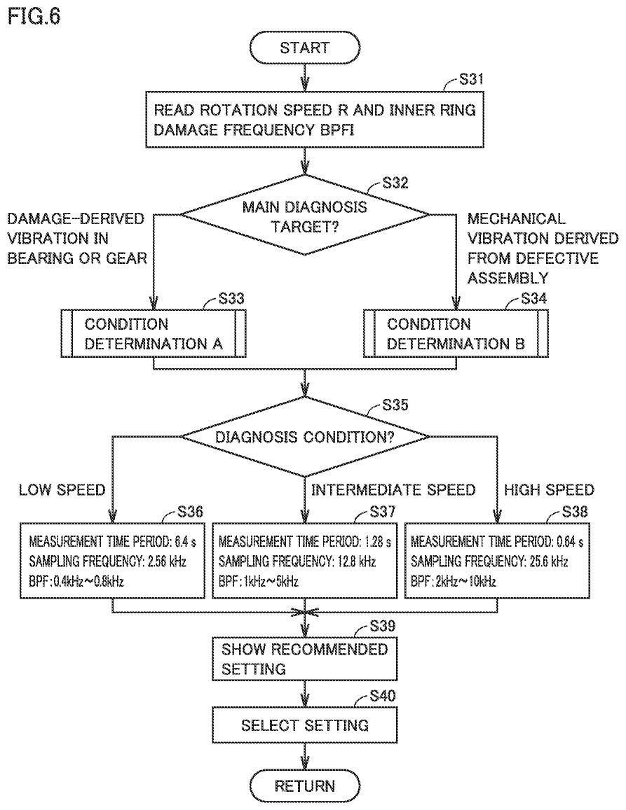

As the sampling frequency and the measurement time period automatically change based on a value calculated from the rotation speed of the diagnosis target and the specification of the bearing, the user can set the sampling frequency and the measurement time period without awareness of restriction imposed on the apparatus. Details of processing in step S14 will be described later with reference to FIG. 6.

When the measurement condition is set in step S14, in step S15, portable information terminal 1 transmits the measurement start signal to measurement instrument 2. Measurement instrument 2 then starts measurement and transmits measurement data after completion of the measurement.

In step S16, abnormality determination unit 11 determines whether or not communication unit 13 has received data from measurement instrument 2. When communication unit 13 has received the data (YES in S16), abnormality determination unit 11 has the data stored in the memory. In step S18, abnormality determination unit 11 determines whether or not the prescribed number of pieces of data has been obtained.

When the prescribed number of pieces of data has not been obtained (NO in S18), processing in step S16 or later is again performed and reception is continued. When the prescribed number of pieces of data has been obtained (YES in step S18), in step S19, abnormality determination unit 11 reads the data from the memory and calculates a frequency spectrum and an envelope spectrum.

In step S20, abnormality determination unit 11 determines whether or not a sign showing an abnormality such as a damaged part of the bearing, misalignment, and imbalance in shaft is observed, and in step S21, abnormality determination unit 11 has a result of determination and a waveform shown on display 14.

In step S22, abnormality determination unit 11 determines whether or not an operation to quit measurement has been performed.

When the operation to quit measurement has not been performed (NO in S22), abnormality determination unit 11 performs again processing from step S12. When the operation to quit measurement has been performed (YES in S22), abnormality determination unit 11 quits processing for vibration analysis.

FIG. 6 is a flowchart showing details of processing for setting a measurement condition in step S14.

In the present embodiment, for automatic setting of a diagnosis condition, the rotation speed of the diagnosis target and the specification of the bearing are necessary. After the initialization processing (S11), the user is instructed to input a rotation speed R and the specification of the bearing (S12). The specification may be stored in advance before processing for automatic setting of the diagnosis condition. A damage frequency for each part of the bearing is then calculated based on inputted rotation speed R and the inputted specification of the bearing (S13). Rotation frequency R and an inner ring damage frequency BPFI which is one of damage frequencies calculated in step S13 are read (S31). In step S32, abnormality determination unit 11 has the user select on the application software, whether the diagnosis target is (A) damage-derived vibration in the bearing or the gear or (B) mechanical vibration derived from defective assembly or the like. While values of rotation speed R read in step S31 and calculated inner ring damage frequency BPFI are held, depending on the diagnosis target selected by the user (S32), processing makes transition to one of a subroutine “condition determination A (S33)” and a subroutine “condition determination B (S34)”. The diagnosis target to be selected by the user in step S32 is either A: damage of the bearing or the gear or B: mechanical vibration derived from defective assembly or the like.

When the user selects (A) damage-derived vibration in the bearing or the gear as the diagnosis target, in step S33, abnormality determination unit 11 selects one diagnosis condition from two values of the rotation speed of the diagnosis target and a bearing inner ring damage frequency calculated based on the internal specification of the bearing.

When the user selects (B) mechanical vibration derived from defective assembly or the like as the diagnosis target, on the other hand, in step S34, abnormality determination unit 11 selects one diagnosis condition based on the rotation speed of the diagnosis target.

When the diagnosis target is A: damage of the bearing or the gear, preferably, an envelope spectrum which is a result of FFT of an envelope waveform resulting from enveloping of a time waveform is checked. When the diagnosis target is B: mechanical vibration derived from defective assembly or the like (for example, misalignment, failure in coupling, loosening, or runout), preferably, a frequency spectrum which is a result of FFT of a time waveform is checked. Therefore, processing is performed in subroutines different from each other; when the diagnosis target is the former, the subroutine for condition determination A is performed, and when the diagnosis target is the latter, the subroutine for condition determination B is performed.

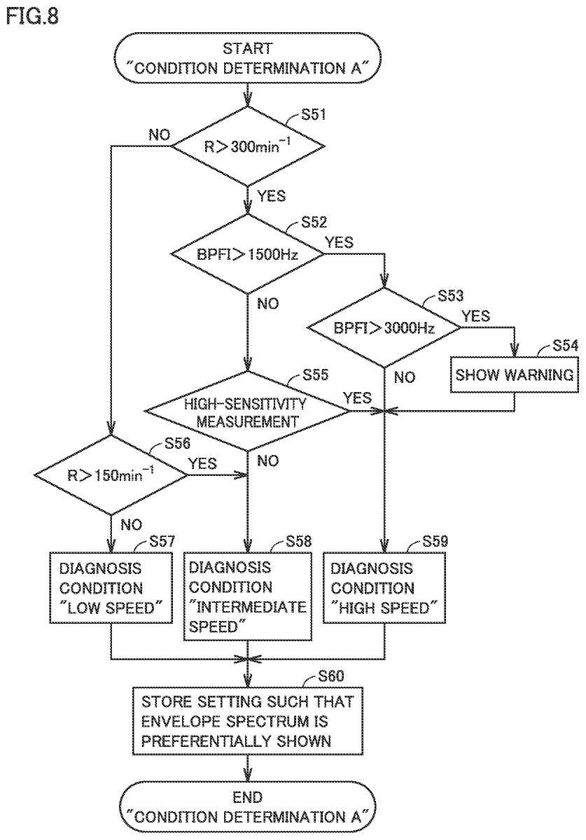

Details of processing in the subroutines in steps S33 and S34 will be described later with reference to FIGS. 8 to 10. In step S35, under which of the low speed, the intermediate speed, and the high speed the diagnosis condition determined in the subroutine falls is determined. When the diagnosis condition falls under the low speed, in step S36, setting corresponding to the low speed is determined as recommended setting. When the diagnosis condition falls under the intermediate speed, in step S37, setting corresponding to the intermediate speed is determined as recommended setting. When the diagnosis condition falls under the high speed, in step S38, setting corresponding to the high speed is determined as recommend setting.

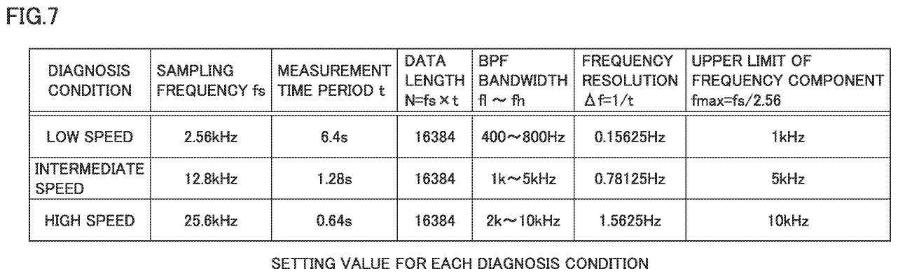

FIG. 7 is a diagram showing diagnosis conditions corresponding to the low speed, the intermediate speed, and the high speed. The diagnosis condition corresponding to the low speed includes a sampling frequency fs=2.56 kHz and a measurement time period t=6.4 s, and at this time, a data length N (=fs×t) is set to N=16384, a BPF bandwidth fl to fh is set to fl to fh=400 to 800 Hz, a frequency resolution Δf (=1/t) is set to Δf=0.15625 Hz, and a frequency component upper limit fmax (=fs/2.56) is set to fmax=1 kHz.

The diagnosis condition corresponding to the intermediate speed includes sampling frequency fs=12.8 kHz and measurement time period t=1.28 s, and at this time, data length N is set to N=16384, BPF bandwidth fl to fh is set to fl to fh=1 k to 5 kHz, frequency resolution Δf is set to Δf=0.78125 Hz, and frequency component upper limit fmax is set to fmax=5 kHz.

The diagnosis condition corresponding to the high speed includes sampling frequency fs=25.6 kHz and measurement time period t=0.64 s, and at this time, data length N is set to N=16384, BPF bandwidth fl to fh is set to fl to fh=2 k to 10 kHz, frequency resolution Δf is set to Δf=1.5625 Hz, and frequency component upper limit fmax is set to fmax=10 kHz.

In succession, abnormality determination unit 11 causes the diagnosis condition determined in one of steps S36 to S38 to be shown on display 14 for proposing the diagnosis condition as a diagnosis condition to be recommended to the user (S39), and has the user select a diagnosis condition. Based thereon, the user determines the diagnosis condition (S40). Preferably, the user can freely change the selected diagnosis condition later.

Thereafter, in step S15 in FIG. 5, vibration of the diagnosis target is measured under the selected diagnosis condition (S36 to S38), and a spectrum is calculated and a result is shown in steps S19 to S21.

A reason why processing for determining a condition and recommended setting are changed depending on a diagnosis target in steps S32 to S38 will now be described.

A factor to be checked in vibration analysis is different between an example in which an abnormality of a machine to be diagnosed is a damage of the bearing or the gear and an example in which the abnormality of the machine to be diagnosed is defective assembly or the like.

In the case of damage of the bearing or the gear (S33), impact vibration occurs in a damaged part, and magnitude of the impact vibration and a cycle of occurrence are factors to be checked in vibration analysis. These two factors can be checked in a result (an envelope spectrum) of FFT of an envelope waveform resulting from enveloping of a time waveform. Specifically, a peak that matches with a frequency (a characteristic frequency) found from the rotation speed and the internal specification of the bearing or the gear appears in an envelope spectrum. By performing processing for extracting a frequency component of the impact vibration with a frequency filter (a BPF in the present embodiment) before enveloping, peaks other than the peak of the characteristic frequency that appears in the envelope spectrum decrease, and hence the peak of the characteristic frequency is relatively more easily observed. In the envelope spectrum, however, there is an upper limit of a frequency that can appear as the peak. Therefore, the inner ring damage frequency highest in characteristic frequency should not exceed the upper limit (which will be shown later in S51, S52, and S53 in FIG. 8). The bandwidth of the BPF preferably encompasses a frequency component as high as possible so as to be able to sense damage of the bearing or the gear early (which will be shown later in S55 in FIG. 8). In the subroutine (which will be described later with reference to FIG. 8) in the example of conditional branching A in which the diagnosis condition for a case where damage of the bearing or the gear is to be diagnosed is set, an optimal diagnosis condition is selected in a branched flow in consideration of the upper limit of the frequency of a reliable peak and early sensing of the damage.

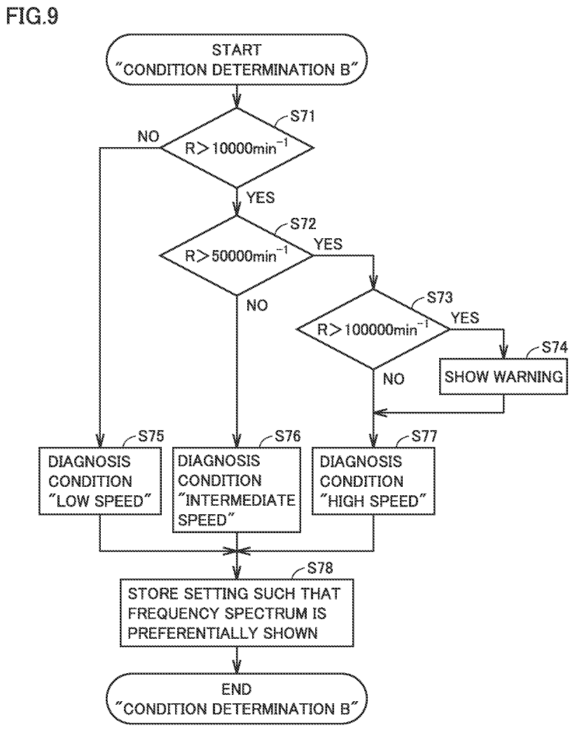

In the case of defective assembly or the like, on the other hand, forced vibration derived from rotation is greater than in a normal operation, and hence magnitude and a frequency of a forced vibration component are factors to be checked in vibration analysis. These two factors can be checked in a result (frequency spectrum) of FFT of a time waveform. Specifically, a peak that matches with a frequency calculated from the rotation speed (a rotation frequency) appears in a frequency spectrum. In the frequency spectrum, however, there is an upper limit of a frequency component of the time waveform based on a sampling theorem. Therefore, the rotation frequency should not exceed the upper limit. Since a frequency resolution of the frequency spectrum improves in proportion to a duration of measurement (a numerical value is in inverse proportion), the duration of measurement is preferably longer. In the subroutine (which will be described later with reference to FIG. 9) in the case of conditional branching B in which the diagnosis conditions in the case of mechanical vibration are set such as the case in which defective assembly or the like is to be diagnosed, an optimal diagnosis condition is set in a branched flow in consideration of appearance of peaks up to a sixth-order component of a rotation frequency in the frequency spectrum.

FIG. 8 is a flowchart of the subroutine (condition determination A) for determining a diagnosis condition when a damage of the bearing or the gear is to be diagnosed.

In diagnosis (condition determination A) of the damage of the bearing or the gear, a peak that appears in an envelope spectrum is checked. The diagnosis target is rotated as many times as possible during measurement, so that a peak indicating a damage becomes sharper and diagnosis is facilitated. In order to include the number of times of rotation minimum necessary for diagnosis during measurement (in order to at least guarantee sharpness of the peak of the envelope spectrum), a value at which branching based on the rotation speed is done in S51 is set to 300 min⁻¹ such that at least three rotations are included within the measurement time period during measurement under any of the three types of diagnosis conditions (the low speed, the intermediate speed, and the high speed) in the present embodiment. For example, when the diagnosis target makes three rotations within 0.64 second under the high-speed condition, it can be expressed as 3 rev/0.64 s=281.25 rev/min., which is lower than 300 min⁻¹. When the rotation speed exceeds 300 min⁻¹ (YES in S51), the process proceeds to processing for determining whether a condition falls under the intermediate-speed condition or the high-speed condition (S52 and S53), and when the rotation speed is equal to or lower than 300 min⁻¹ (NO in S51), the process proceeds to processing for determining whether a condition falls under the low-speed condition or the intermediate-speed condition (S56).

The envelope spectrum is a graph showing an interval between occurrences of impact vibration in a frequency domain. When the interval between occurrences of impact vibration is extremely short, a breakpoint between impact waveforms becomes unclear and a peak indicating an impact waveform does not appear in the envelope spectrum. A maximum value of a frequency of a peak that appears in the envelope spectrum is calculated from a reciprocal of a limit value (cycle) of the interval between occurrences of vibration. The limit value of the interval between occurrences is generally calculated by dividing a value (the number of pieces of data) around ten by a sampling frequency. In the present embodiment, in consideration of an error between a reciprocal (12800 Hz/8=1600 Hz and 25600 Hz/8=3200 Hz) calculated by dividing the number of pieces of data which is eight by the sampling frequency and the rotation speed associated with control of a motor, maximum frequencies of envelope spectra at the intermediate speed and the high speed are determined as 1500 Hz and 3000 Hz, respectively.

When the frequency (characteristic frequency) indicating damage of the bearing and the gear exceeds the maximum frequency described above, a peak of the characteristic frequency does not appear in the envelope spectrum and diagnosis cannot be conducted. Therefore, the condition for the intermediate speed or the condition for the high speed is selectively set as the diagnosis condition based on whether or not the inner ring damage frequency (BPFI) highest among the characteristic frequencies exceeds the maximum frequency at the intermediate speed or the high speed (BPFI>1500 Hz in S52 and BPFI>3000 Hz in S53).

At a rotation speed that does not satisfy the condition of BPFI>1500 Hz (NO in S52), diagnosis can be conducted under any of the intermediate-speed and high-speed conditions. A frequency band of vibration produced by damage of the bearing is generally a band of several kilohertz (kHz). In particular, an initial damage tends to appear in a frequency band on a high-frequency side. Therefore, when the user desires sensing of the damage of the bearing with good sensitivity (YES in S55), diagnosis under the high-speed condition (S59) is preferred even when the rotation speed falls under the rotation speed at which measurement can be conducted under the intermediate-speed condition.

As shown in FIG. 7, in the frequency spectrum under the intermediate-speed condition (S58), the maximum frequency is 5 kHz and the band of the BPF is from 1 kHz to 5 kHz, whereas in the frequency spectrum under the high-speed condition (S59), the maximum frequency is 10 kHz and the band of the BPF is from 2 kHz to 10 kHz. Therefore, the high-speed condition (S59) is more likely to enable sensing of the damage of the bearing than the intermediate-speed condition (S58), because diagnosis can be conducted in a frequency band with a greater margin around the band of several kilohertz which is the band of the frequency exhibited by the damage of the bearing.

As the damage of the bearing progresses and the bearing comes to the end of its life, the frequency band of the damage of the bearing makes transition to a low frequency band. The reason why the low-speed condition encompasses a maximum frequency and a BPF bandwidth out of the frequency band of the damage of the bearing is to facilitate sensing of the bearing that has come to the end of its life. As the rotation speed of the diagnosis target is low, a speed of development of the damage also becomes lower. Therefore, even when the bearing comes to the end of its life in daily diagnosis, there is some time allowed before replacement of the bearing.

In diagnosis of vibration, early detection of an abnormality is preferred. Therefore, in processing for determining whether the low-speed condition or the intermediate-speed condition is to be set (S56), the intermediate-speed condition (S58) is selected if a rotation speed falls under the rotation speed (higher than 150 min⁻¹) at which diagnosis can at least be conducted under the intermediate-speed condition (S58).

At such a rotation speed as satisfying the condition of BPFI>3000 Hz (YES in S53), a peak indicating the damage of the inner ring does not appear in the envelope spectrum. Therefore, when this condition is satisfied, a warning indicating whether or not aimed diagnosis can be conducted is shown to the user (S54). Depending on a rotation speed, a bearing, or a gear, a peak indicating a damage other than the damage of the inner ring may appear in the envelope spectrum, and hence it cannot be concluded that diagnosis cannot totally be conducted. Therefore, when a warning is shown (S54), a peak indicating a damage of which element does not appear is clearly shown, and the user is notified of lowering in accuracy in diagnosis.

As the diagnosis condition is determined in one of steps S57, S58, and S59, in step S60, setting is stored to preferentially show the envelope spectrum, and the processing in the subroutine for condition determination A ends. Thereafter, processing in step S35 in FIG. 6 is performed.

FIG. 9 is a flowchart of the subroutine (condition determination B) for determining a diagnosis condition when mechanical vibration derived from defective assembly or the like is to be diagnosed.

In diagnosis of mechanical vibration derived from defective assembly or the like, a peak that appears in the frequency spectrum is checked. Since mechanical vibration results from rotation, magnitude and a frequency (a rotation frequency=rotation speed min⁻¹/60) of the vibration appear as the peak. In making distinction as to defective assembly based on the peak of the rotation frequency, how a harmonic component of the rotation frequency appears is checked. For example, in the case of misalignment, a peak of a second-order component rather than a peak of a first-order component is often larger in the frequency spectrum. Since a frequency resolution of the frequency spectrum becomes better (intervals between lines of the frequency spectrum are finer) in proportion to a duration of measurement, the duration of measurement is preferably longer. Based on the sampling theorem, however, a frequency component equal to or lower than half the sampling frequency cannot be shown, and hence this fact should be taken into consideration. In general, a value calculated by dividing the sampling frequency by 2.56 is used as the upper limit. In the present embodiment, in consideration of the upper limit of the frequency, the diagnosis condition is determined based on the rotation speed in steps S71, S72, and S73 such that peaks at least up to a sixth-order component of the rotation frequency appear in the frequency spectrum. As in the flowchart shown in FIG. 8, when the user inputs a rotation speed at which peaks up to the sixth-order components of the rotation frequency do not appear (YES in S73), a warning clearly indicative of that effect is shown (S74).

When the diagnosis condition is determined in one of steps S75, S76, and S77, in step S78, setting is stored to preferentially show the frequency spectrum, and the processing in the subroutine for condition determination B ends. Thereafter, processing in step S35 in FIG. 6 is performed.

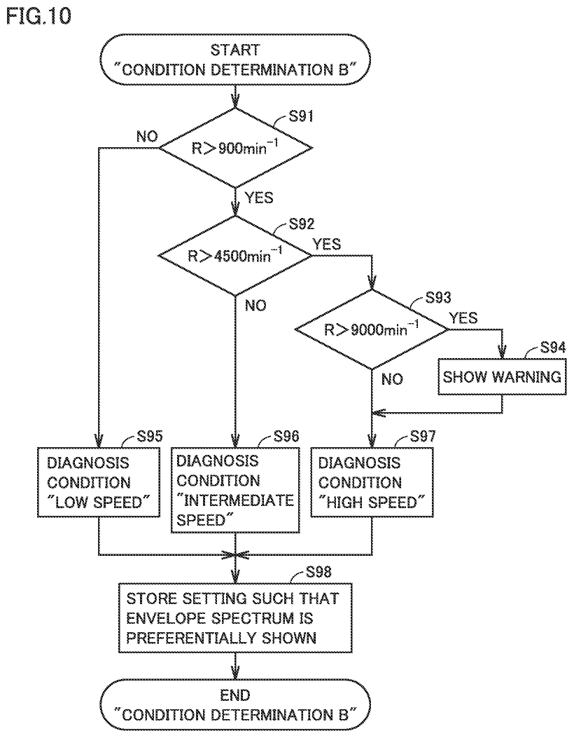

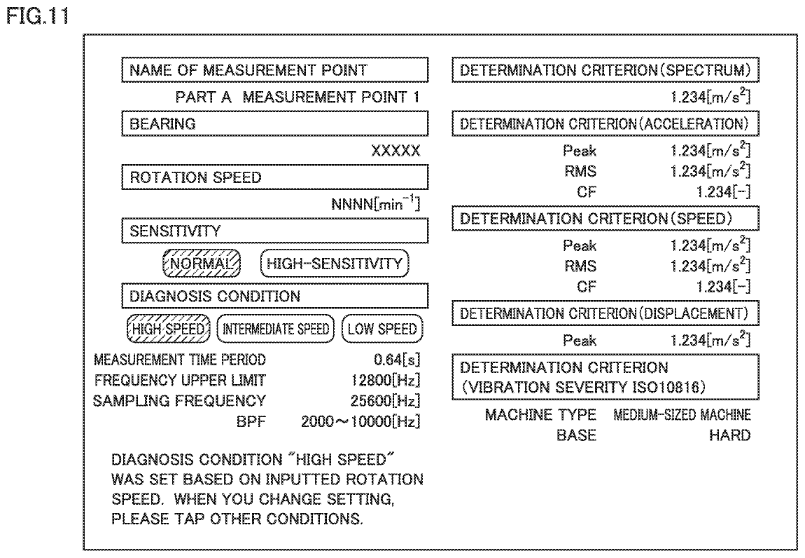

FIG. 10 is a flowchart of the subroutine (condition determination B) for determining a diagnosis condition in a modification to FIG. 9 in consideration also of a damage of the bearing or the gear.

In condition determination in FIG. 9, damage of the bearing or the gear can be checked based on the envelope spectrum. Depending on the rotation speed of the diagnosis target or the type of the bearing/the gear, however, a peak indicating the damage does not appear due to restriction of a frequency beyond which a peak indicating an impact waveform does not appear in the envelope spectrum. Therefore, depending on whether vibration falls under damage-derived vibration of the bearing or the gear or mechanical vibration, selection between diagnosis conditions A and B is made. In the case of such mechanical vibration that impact vibration occurs each time of rotation, however, a peak appears in the rotation frequency in the envelope spectrum. In the envelope spectrum, a peak indicating the damage of the bearing or the gear could also be checked. Though the diagnosis condition is determined based on the rotation speed such that peaks at least up to the sixth-order component of the rotation frequency appear in the frequency spectrum as described above, this diagnosis condition may also include a rotation speed at which a peak indicating the damage of the bearing or the gear is incorporated in the spectrum to some extent, an example of which will be described below.

A ratio between the rotation frequency and the inner ring damage frequency among bearing specifications held in the portable information terminal (application) is calculated, and the inner ring damage frequency is assumed as twenty times as high as the rotation frequency at the maximum. When the maximum frequency (2560 Hz/8=320 Hz) of the envelope spectrum in the example where the diagnosis condition is set to the low-speed condition matches with the inner ring damage frequency, the upper limit of the rotation speed is 960 min⁻¹ because the rotation frequency is calculated as 320/20=16 Hz based on the aforementioned ratio. Even though the rotation speed is controlled, it actually increases or decreases. Therefore, if the rotation speed is assumed to increase or decrease by 5% in consideration also of such a tendency, an approximate upper limit is 900 min⁻¹ (S91). Similarly, criterion values for the intermediate-speed and high-speed conditions are calculated as 4500 min⁻¹ (S92) and 9000 min⁻¹ (S93), respectively.

With such determination, in condition determination B as well, the damage of the bearing and the gear can be checked in the envelope spectrum. In condition determination B, however, optimal setting for sensing of the damage of the bearing or the gear is not made as in condition determination A. Therefore, condition determination B is more disadvantageous than condition determination A in early sensing of the damage. The flowchart in FIG. 10 may substitute for the flowchart in FIG. 9. As an option in an example where diagnosis mainly of mechanical vibration is desired whereas diagnosis of the bearing at minimum is also desired, in addition to branch to two options of condition determination A shown in FIG. 8 and condition determination B shown in FIG. 9, processing in FIG. 10 may be added as a condition C and step S32 may be branched to three options of condition determinations A to C.

FIG. 11 is a diagram showing an exemplary screen for setting a measurement condition or the like shown on display 14. Values set in left half of this screen are used for a bearing model, a rotation speed, and sensitivity necessary in step S12 in FIG. 4. As the values of the bearing model, the rotation speed, and the sensitivity are inputted, an optimal diagnosis condition is automatically selected and shown in right half of the screen in vibration analysis apparatus 1. Though the selected diagnosis condition is not limited, preferably, the diagnosis condition is not fixed but the user is allowed to freely change the diagnosis condition after automatic selection.

FIG. 12 is a diagram showing a mathematical expression of a bearing characteristic frequency (BPFO, BPFI, and BSF). A parameter for abnormality determination unit 11 to identify a damaged part of the diagnosis target is stored in database unit 15 in FIG. 1.

When the specification of the bearing is adopted as this parameter, abnormality determination unit 11 calculates the vibration frequency (BPFI) derived from a flaw in the inner ring of the bearing, the vibration frequency (BPFO) derived from a flaw in the outer ring of the bearing, and the vibration frequency (BSF) derived from a flaw in the rolling element of the bearing, based on the specification of the bearing (a pitch circle diameter D of the bearing, a diameter d of the rolling element, an angle of contact α of the rolling element, and the number Z of rolling elements) and a rotation frequency f₀ of a shaft of the inner ring based on the expressions as shown in FIG. 12.

A coefficient in an expression calculated in advance in correspondence with the bearing model number may be adopted as this parameter. The coefficient in the case of the (expression 1) in FIG. 12 is Z/2*(1+d/D*cos α), and the BPFI is obtained by multiplying the coefficient by rotation frequency f₀. The coefficient in the case of the (expression 2) in FIG. 12 is Z/2*(1−d/D*cos α), and the BPFO is obtained by multiplying the coefficient by rotation frequency f₀. The coefficient in the case of the (expression 3) in FIG. 12 is Z/(2d)*(1−(d/D)²*cos²α), and the BSF is obtained by multiplying the coefficient by rotation frequency f₀.

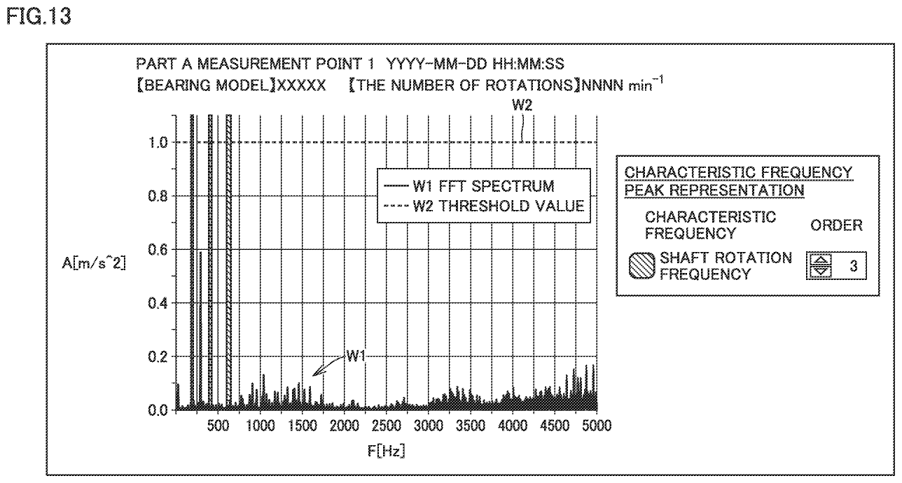

FIG. 13 is a diagram showing exemplary representation of a frequency spectrum shown on display 14. Abnormality determination unit 11 has the frequency spectrum and the envelope spectrum of measured vibration shown on display 14. A spectrum to preferentially be shown is switched as shown in step S60 in FIG. 8, step S78 in FIG. 9, and step S98 in FIG. 10, depending on the diagnosis target (damage-derived vibration of the bearing or the gear or vibration of the machine) selected in step S32 in FIG. 6. Preferably, the user can freely switch the automatically preferentially shown spectrum to another spectrum later, without being limited.

It is not easy to find out whether or not a peak of a characteristic frequency appears simply based on representation of the spectrum. In a screen for showing a spectrum shown in FIG. 13, a range (−10% to 5% of the characteristic frequency) where a peak of the characteristic frequency including a harmonic is expected to appear is shown with a colored band. Though a threshold value W2 is shown for an FFT spectrum W1 in the example in FIG. 13, in addition thereto, a shaft rotation frequency is selected as the characteristic frequency, and bands corresponding to harmonics up to the third order of this characteristic frequency are shown. By checking whether or not a peak of FFT spectrum W1 is present in these bands, even the beginner can visually determine whether or not the characteristic of the damage is found in FFT spectrum W1. In other words, with the screen as in FIG. 13, whether or not the value of spectrum W1 included in the range of the damage exceeds threshold value W2 which is a set criterion value can be shown in an easy-to-understand manner.

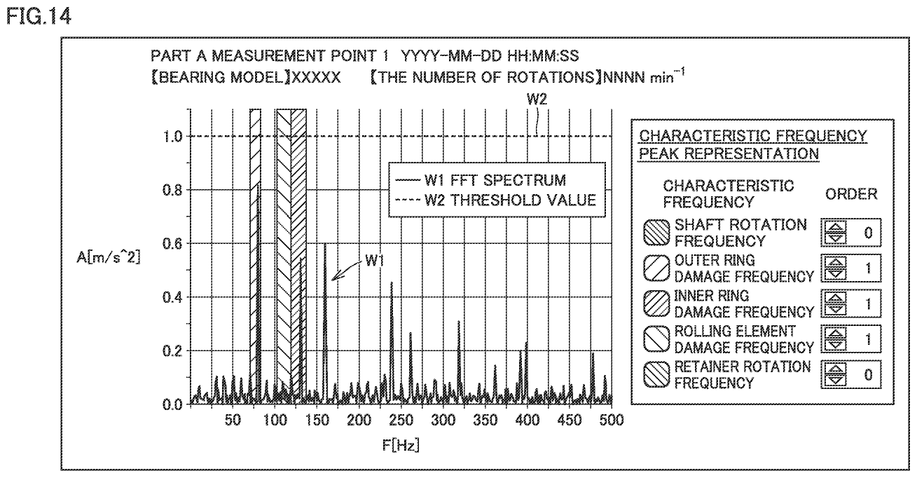

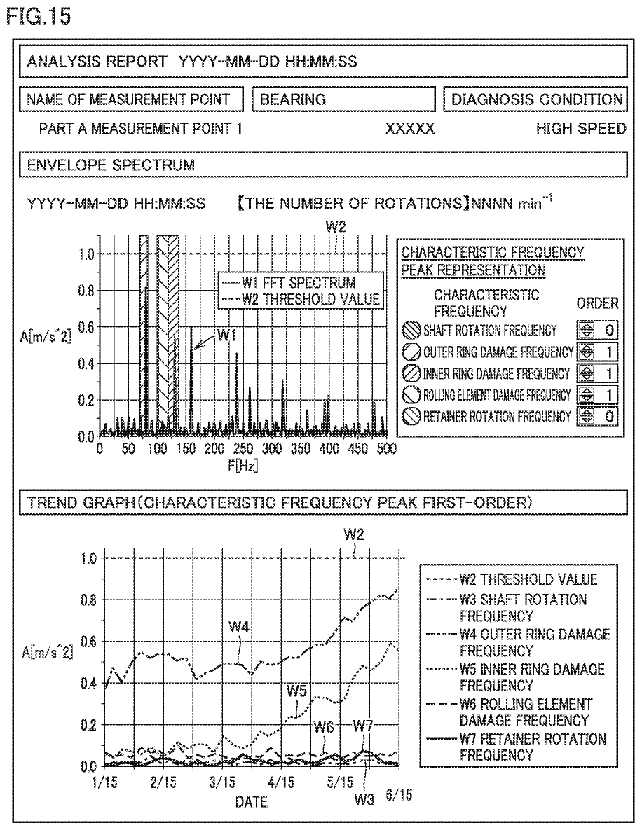

FIG. 14 is a diagram showing exemplary representation of an envelope spectrum shown on display 14. Though threshold value W2 for FFT spectrum W1 is shown in the example in FIG. 14, in addition thereto, the outer ring damage frequency, the inner ring damage frequency, and the rolling element damage frequency are selected as the characteristic frequencies, and bands corresponding to first-order fundamental waves thereof are shown with hatchings different from one another. In the actual screen, a band showing a range of the spectrum where a peak of the rotation frequency, the bearing characteristic frequency, or the like which indicates a damage of a part is expected to appear is shown in different color. By checking whether or not the peak of FFT spectrum W1 is present in this band, even the beginner can visually determine whether or not the characteristic of the damage is present in FFT spectrum W1.

In the present embodiment, the diagnosis condition determined in step S14 in FIG. 5 is applied and vibration is measured with measurement instrument 2. When (A) damage-derived vibration in the bearing or the gear is selected in step S32 in FIG. 6, in step S21, the envelope spectrum as shown in FIG. 13 is shown on display 14. When (B) mechanical vibration derived from defective assembly or the like is selected in step S32 in FIG. 6, in step S21, the frequency spectrum as shown in FIG. 14 is shown on display 14. Representation at this time is merely preferential representation of one of the envelope spectrum and the frequency spectrum over the other, and the user is preferably allowed to freely make switching.

FIG. 15 is a diagram showing an exemplary analysis report outputted from portable information terminal 1. In the present embodiment, a result of measurement is shown on portable information terminal 1. When portable information terminal 1 has a small size, checking of the result of diagnosis on the screen imposes burden on the user. Re-checking of the result also requires time and efforts for operating the terminal each time, and even when the result is successfully shown, it is difficult to share information by showing the screen. In order to solve this problem, abnormality determination unit 11 is configured to output such a report as allowing checking of the result of diagnosis and a history of data measured until now in an image data format (for example, PDF, PNG, or the like) through communication unit 13. The outputted report can be shown on a large screen with the use of a personal computer or printed by a printer. FIG. 15 shows the envelope spectrum in the upper tier and shows a trend graph of a first-order peak of the characteristic frequency in the lower tier. Without being limited as such, the frequency spectrum may be shown as the spectrum in the upper tier, and a list of physical quantities (a maximum value of an effective value or an absolute value, a crest factor, or the like) obtained from measured vibration data may be shown as the trend graph in the lower tier. Alternatively, the frequency spectrum may be shown in the upper tier and the envelope spectrum may be shown in the lower tier, or trend graphs may be shown in both of the upper tier and the lower tier.

As shown above, according to the present embodiment, with the application software that runs on the portable information terminal, setting for vibration measurement can be made, the measurement instrument can be controlled, data can be analyzed, and a result can be shown.

FIG. 16 is a diagram showing a modification of the vibration analysis system. As shown in FIG. 16, a portable information terminal 1A and a measurement instrument 2A may be configured to communicate with each other through a wire.

Though not shown, various modifications as below may be incorporated.

[Extension of Measurement Time Period]

As set forth in the description with reference to FIG. 8, the diagnosis target is rotated as many times as possible during measurement, so that a peak indicating the damage becomes sharper and diagnosis is facilitated. When the high-speed condition is set as the diagnosis condition, diagnosis is difficult unless the rotation speed is equal to or higher than approximately 280 min⁻¹. Since it takes time for delivery or preparation for replacement of a large-sized bearing low in rotation speed, early sensing of the damage of the bearing is often desired. In the present embodiment, though the intermediate-speed or high-speed condition is preferably set as the diagnosis condition for early detection of a damage, it is difficult to conduct diagnosis due to the influence of the rotation speed described previously. Thus, depending on the diagnosis target, measurement and analysis of vibration desired by the user may not be conducted due to restriction of the data length described in 0032 or 0033. By repeating measurement under the intermediate-speed or high-speed condition and increasing the measurement time period to 2.56 seconds and to 5.12 seconds, a measurement time period sufficient for diagnosis can be secured. Load or a data capacity in data processing, however, becomes larger as the measurement time period is longer, to which attention should be paid. Therefore, extension of the measurement time period in the present approach is a function for the experienced as compared with an approach to semiautomatic setting of the diagnosis condition which is the approach for the beginner of vibration analysis shown in FIGS. 8, 9, and 10.

The measurement time period necessary for diagnosis is calculated based on the rotation speed inputted by the user. For example, when it is assumed that the rotation speed of the diagnosis target is 150 min⁻¹ and the guideline of the number of rotations minimum necessary for analysis is three, the measurement time period is calculated as 3 rev*(60 s/150 rpm)=1.2≈1.28 s. When the function to extend the measurement time period is used and when the measurement time period exceeding a duration sufficient for analysis is set, an unnecessary data portion is also included in processing and storage of data. For example, when the measurement time period is set to 5.12 s for the aforementioned rotation speed of 150 min⁻¹, a time length of data required for minimum analysis is 1.28 s and data for remaining 3.84 s is unnecessary. By setting the upper limit of the data length (the product of the measurement time period and the sampling frequency) in consideration of the load of data processing and the data capacity, the bearing and the gear that rotate at a low speed can be measured and diagnosed under the intermediate-speed and high-speed conditions. By providing a function for automatic setting of the data length based on the rotation speed, even the beginner of vibration analysis can extend the measurement time period within a range where the system and equipment in the present patent soundly function. The present function is a function different from and independent of automatic selection of the diagnosis condition shown in FIGS. 8, 9, and 10, and preferably, the user can freely select the present function.

[Detailed Analysis (Change of BPF Range and Re-Calculation of Envelope Spectrum)]

In the present embodiment, vibration is measured and diagnosed under three conditions of the low speed, the intermediate speed, and the high speed. The present equipment is configured to select setting necessary for analysis of vibration from three patterns (the low speed, the intermediate speed, and the high speed) based on the diagnosis target and an operating status such that vibration can be analyzed with certain accuracy being maintained, regardless of the skill level of the user. In analysis of vibration in detail, not only diagnosis is conducted based on these three conditions, but also whether or not a characteristic of the damage is observed in a frequency band other than those under these conditions is preferably checked. Data measured under a selected condition (an unprocessed and raw vibration waveform) may be stored, and a function to show the envelope spectrum with the bandwidth of the frequency filter being varied may be provided.

[Measurement with Timer]

Depending on the diagnosis target, abnormal vibration may occur only for a short time period. In an example where abnormal vibration occurs for several seconds immediately after pressing of an operation button in a machine including the diagnosis target, in using present equipment for which the measurement time period is short, an operation button in the machine and a measurement start button in the present equipment should substantially simultaneously be pressed. In a factory, for a safety reason, simultaneously doing different works with two hands is often prohibited, and two workers are required for simultaneous pressing of the buttons. In order to solve this problem, the user is allowed to set a time period from pressing of the measurement start button in the present equipment until start of measurement like a self-timer of a camera, so that even a single worker can conduct measurement aiming at abnormal vibration.

[Proposal of Re-Measurement]

In some cases, a characteristic of a damage does not appear under the diagnosis condition selected based on the rotation speed and the specification of the bearing but the characteristic of the damage may appear under a diagnosis condition different from the selected diagnosis condition. Such a case will occur unless the bandwidth of the BPF set for each condition includes a frequency band of vibration caused by the damage. For example, when a frequency band of vibration caused by the damage is around 1 kHz, this band is out of the bandwidth from 2 kHz to 10 kHz of the BPF under the high-speed condition. Therefore, in this case, a peak indicating the damage is less likely to appear in the envelope spectrum measured under the high-speed condition. On the other hand, under the intermediate-speed condition (the BPF being from 1 kHz to 5 kHz) under which information around 1 kHz can be included, a peak indicating the damage is more likely to appear. Therefore, in order to avoid a damage remaining undetected, when the characteristic of the damage is not observed as a result of analysis of vibration measured under the diagnosis condition selected based on the rotation speed and the specification of the bearing, measurement under a condition different from the condition for measurement that was conducted is proposed to the user. This proposal is made, for example, by representation on display 14.

[Selection of Diagnosis Condition Based on Comparison of Data]

As described in the modification where re-measurement is proposed above, a characteristic of a damage may not appear under the diagnosis condition selected based on the rotation speed and the specification of the bearing. Such a case is highly likely to occur in a machine that has been operated for a certain time period where a state of the damage of the diagnosis target is completely unknown. Thus, rather than selection based on the rotation speed and the specification of the bearing, vibration in the diagnosis target is measured under all of the three conditions of the low speed, the intermediate speed, and the high speed, and a condition under which a characteristic indicating the damage most strongly appears is selected as the diagnosis condition to be used for future monitoring.

[Determination of Characteristic of Damage]

In the modification where re-measurement is proposed and the modification where the diagnosis condition is selected based on comparison of data, a method of proposing re-measurement or selecting a diagnosis condition based on whether or not a characteristic of the damage is observed is described. A method of determining whether or not a characteristic of a damage is observed will be described below.

In the present embodiment, a characteristic of a damage is determined based on a criterion value (threshold value) set by the user. The user inputs a criterion value in advance before measurement, and when a peak exceeding the value appears, the characteristic of the damage is determined as being observed. The criterion value may be applied simply to a maximum value of a spectrum or to a value largest among peaks (a rotation frequency, a bearing characteristic frequency, and the like) indicating the damage.

When determination is made based on the peak indicating the damage, an area of the peak may be taken into consideration. Though the peak indicating the damage is found from the rotation speed, an actual rotation speed may often be different from an inputted value. For example, in the case of a motor, slip occurs and the rotation speed slightly lowers. When the rotation speed is different from the inputted value, a theoretical value is different from a frequency of an actual peak and correct determination cannot be made. Therefore, an area of a spectrum included within a range (for example, −10% to 5% of the characteristic frequency) of the frequency where a peak is expected to appear in consideration in advance of increase and decrease of the rotation speed may be regarded as an area of the peak, and whether or not the characteristic of the damage is observed may be determined.

In the description above, a largest peak is picked up and whether or not a characteristic of the damage is observed is determined. There are, however, a plurality of types of peaks indicating damages, such as a rotation frequency and a bearing characteristic frequency, and hence they may be taken into consideration. When the number of peaks designated in advance among peaks indicating damages exceeds a criterion value, determination as the damage may be made. Alternatively, determination may be made based only on a specific peak, as in the case where determination as damage is made when the “outer ring damage frequency” exceeds a criterion value. A designation method at this time may be designated in advance on a source code, or may freely be selected by the user on application software.

Though a commercial product of this type is desirably easily attached to and removed from a measurement target, it should also be devised not to fall therefrom on such occasions. Therefore, when the measurement instrument is in a vertically long shape in a direction perpendicular to an installation surface, the measurement instrument is desirably in a shape of an hourglass having a central portion of a housing recessed. Thus, a finger tends to be hooked at the time of attachment and removal, and possibility of falling can be lowered.

(Summary)

The present embodiment is finally summarized with reference again to the drawings.

The present embodiment relates to a vibration analysis apparatus that diagnoses a machine state based on detected vibration. Vibration analysis apparatus 1 shown in FIG. 3 includes setting unit 12 that sets a diagnosis target, a rotation speed, and a determination criterion value, condition determination unit 16 that determines a diagnosis condition based on information on the diagnosis target, analyzer 17 that subjects inputted data to frequency analysis, and abnormality determination unit (central processing unit) 11 that makes determination as to an abnormality of the diagnosis target based on the determination criterion value.

Preferably, the diagnosis target includes at least one of a bearing, a gear, and a rotation shaft.

More preferably, vibration analysis apparatus 1 further includes database unit 15 in which a parameter for abnormality determination unit 11 to identify a damaged part of the diagnosis target is stored. In database unit 15, (1) a rotation speed of the bearing and (2) a coefficient in a mathematical expression are stored as the parameter. This mathematical expression is a mathematical expression for calculating based on a specification of the bearing or the rotation speed, a vibration frequency derived from a flaw in an inner ring of the bearing, a vibration frequency derived from a flaw in an outer ring of the bearing, and a vibration frequency derived from a flaw in a rolling element of the bearing.

More preferably, the information is a rotation speed of the diagnosis target and an inner ring damage frequency of the bearing, and condition determination unit 16 selects a condition corresponding to the information as the diagnosis condition.

More preferably, condition determination unit 16 selects the diagnosis condition from a plurality of conditions in which a sampling frequency and a measurement time period are adjusted such that the number of pieces of data is equal.

Preferably, vibration analysis apparatus 1 further includes display 14. When a peak indicating a damage of the diagnosis target does not theoretically appear in a frequency spectrum or an envelope spectrum under combined conditions of the rotation speed of the diagnosis target, an inner ring frequency of the bearing, and the diagnosis condition, abnormality determination unit 11 has display 14 provide representation asking a user whether or not to conduct measurement.

More preferably, abnormality determination unit 11 extends the measurement time period set for each diagnosis condition based on the rotation speed of the diagnosis target.

More preferably, the diagnosis condition identifies a filter that restricts a frequency band of a vibration detection signal. Abnormality determination unit 11 calculates after diagnosis under the diagnosis condition, an envelope spectrum of vibration data subjected to filtering of a frequency band different from the frequency band in the diagnosis condition.

More preferably, when abnormality determination unit 11 determines that a characteristic of a damage is not observed after diagnosis under the diagnosis condition, abnormality determination unit 11 proposes to a user to conduct re-measurement and diagnosis under a condition different from the diagnosis condition.

More preferably, abnormality determination unit 11 sets, based on a result of measurement and diagnosis under a plurality of conditions in first diagnosis, a condition under which the abnormality determination unit has determined that a characteristic of a damage that a user particularly desires to monitor appears, as the diagnosis condition to be used from now on.

More preferably, the determination criterion value includes a criterion value on which determination that the characteristic of the damage is not observed in the diagnosis target is based. The criterion value is set for an area of a spectrum included within a range of a frequency where a peak is expected to appear, in consideration of increase and decrease of the rotation speed in advance.

Preferably, vibration analysis apparatus 1 further includes display 14. Abnormality determination unit 11 causes display 14 to show in a graph of a frequency spectrum or an envelope spectrum, a range where a first-order frequency peak indicating a damage of the bearing, the gear, or the rotation shaft is expected to appear.

More preferably, as shown in FIG. 13, abnormality determination unit 11 causes display 14 to show in the graph, a range where a frequency peak indicating a damage of the bearing, the gear, or the rotation shaft is expected to appear, up to an order equal to or more than a second order.

As shown in FIG. 15, abnormality determination unit 11 outputs, in an image data format, a report in which a result of diagnosis and a history of a result of past measurement can be checked.

In another aspect, the present embodiment relates to a vibration analysis system. The vibration analysis system includes measurement instrument 2 that measures vibration of a diagnosis target and vibration analysis apparatus 1 described anywhere above. Vibration analysis apparatus 1 is implemented by application software that runs on a portable information terminal.

More preferably, as shown in FIG. 1, portable information terminal 1 and measurement instrument 2 wirelessly communicate with each other. As shown in FIG. 16, communication through a wire may be applicable.

More preferably, when measurement unit 2 has a vertically long shape, it is in a shape of an hourglass having a central portion of a housing recessed.

According to the vibration analysis apparatus in the present embodiment, setting relating to analysis is automatically selected based on information (a bearing model or a rotation speed) on a diagnosis target inputted by a user so that vibration analysis can be conducted with certain accuracy being maintained, regardless of a skill level of the user.

With the function to repeatedly conduct measurement under a selected diagnosis condition, measurement for a time period equal to or longer than the set measurement time period can also be conducted. Since measurement for a long time at a high sampling frequency can thus be conducted, a damage can be detected early also for a diagnosis target low in rotation speed. If a data length is automatically set based on the rotation speed in consideration of load imposed by data processing or a data capacity which is a disadvantage of extension of the measurement time period, such a disadvantage could be minimized.

Furthermore, since an envelope spectrum for once measured data can again be calculated with a bandwidth of the frequency filter being varied, detailed analysis can be conducted.

Since a time period from pressing of a measurement start button in the vibration analysis apparatus until start of measurement can be set, the button in the vibration analysis apparatus and a start button in equipment to be diagnosed do not have to simultaneously be pressed, so that even a single worker can conduct measurement aiming at abnormal vibration.

It should be understood that the embodiment disclosed herein is illustrative and non-restrictive in every respect. The scope of the present invention is defined by the terms of the claims rather than the description of the embodiment above and is intended to include any modifications within the scope and meaning equivalent to the terms of the claims.

### REFERENCE SIGNS LIST

1, 1A portable information terminal; 2, 2A measurement instrument; 11 abnormality determination unit; 12 setting unit; 13 communication unit; 14 display; 15 database unit; 16 condition determination unit; 17 analyzer; 21 microcomputer; 22 memory; 23 communication module; 24 converter; 25 anti-aliasing filter; 26 acceleration sensor; 100 vibration analysis system

1. A vibration analysis apparatus that diagnoses a machine state based on detected vibration, the vibration analysis apparatus comprising:
a setting unit that sets a diagnosis target, a rotation speed, and a determination criterion value;
a condition determination unit that determines a diagnosis condition based on information on the diagnosis target;
an analyzer that subjects inputted data to frequency analysis; and
an abnormality determination unit that makes determination as to an abnormality of the diagnosis target based on the determination criterion value.

2. The vibration analysis apparatus according to claim 1, wherein
the diagnosis target includes at least one of a bearing, a gear, and a rotation shaft.

3. The vibration analysis apparatus according to claim 2, further comprising a database unit in which a parameter for the abnormality determination unit to identify a damaged part of the diagnosis target is stored, wherein
in the database unit,
a rotation speed of the bearing, and
a specification of the bearing or a coefficient in a mathematical expression are stored as the parameter, and
the mathematical expression calculates based on the rotation speed, a vibration frequency derived from a flaw in an inner ring of the bearing, a vibration frequency derived from a flaw in an outer ring of the bearing, and a vibration frequency derived from a flaw in a rolling element of the bearing.

4. The vibration analysis apparatus according to claim 3, wherein
the information is a rotation speed of the diagnosis target and an inner ring damage frequency of the bearing, and
the condition determination unit selects a condition corresponding to the information as the diagnosis condition.

5. The vibration analysis apparatus according to claim 4, wherein
the condition determination unit selects the diagnosis condition from a plurality of conditions in which a sampling frequency and a measurement time period are adjusted such that the number of pieces of data is equal.

6. The vibration analysis apparatus according to claim 5, further comprising a display, wherein
when a peak indicating a damage of the diagnosis target does not theoretically appear in a frequency spectrum or an envelope spectrum under combined conditions of the rotation speed of the diagnosis target, an inner ring frequency of the bearing, and the diagnosis condition, the abnormality determination unit has the display provide representation asking a user whether to conduct measurement.

7. The vibration analysis apparatus according to claim 5, wherein
the abnormality determination unit extends the measurement time period set for each diagnosis condition based on the rotation speed of the diagnosis target.

8. The vibration analysis apparatus according to claim 5, wherein
the diagnosis condition identifies a filter that restricts a frequency band of a vibration detection signal, and
the abnormality determination unit calculates after diagnosis under the diagnosis condition, an envelope spectrum of vibration data subjected to filtering of a frequency band different from the frequency band in the diagnosis condition.

9. The vibration analysis apparatus according to claim 5, wherein
when the abnormality determination unit determines that a characteristic of a damage is not observed after diagnosis under the diagnosis condition, the abnormality determination unit proposes to a user to conduct re-measurement and diagnosis under a condition different from the diagnosis condition.

10. The vibration analysis apparatus according to claim 5, wherein
the abnormality determination unit sets, based on a result of measurement and diagnosis under a plurality of conditions in first diagnosis, a condition under which the abnormality determination unit has determined that a characteristic of a damage that a user particularly desires to monitor appears, as the diagnosis condition to be used from now on.

11. The vibration analysis apparatus according to claim 9, wherein
the determination criterion value includes a criterion value on which determination that the characteristic of the damage is not observed in the diagnosis target is based, and the criterion value is set for an area of a spectrum included within a range of a frequency where a peak is expected to appear in consideration of increase and decrease of the rotation speed in advance.

12. The vibration analysis apparatus according to claim 3, further comprising a display, wherein
the abnormality determination unit causes the display to show in a graph of a frequency spectrum or an envelope spectrum, a range where a first-order frequency peak indicating a damage of the bearing, the gear, or the rotation shaft is expected to appear.

13. The vibration analysis apparatus according to claim 12, wherein
the abnormality determination unit causes the display to show in the graph, a range where a frequency peak indicating a damage of the bearing, the gear, or the rotation shaft is expected to appear, up to an order equal to or more than a second order.

14. The vibration analysis apparatus according to claim 1, wherein
the abnormality determination unit outputs, in an image data format, a report in which a result of diagnosis and a history of a result of past measurement can be checked.

15. A vibration analysis system comprising:
a measurement instrument that measures vibration of a diagnosis target; and
the vibration analysis apparatus according to claim 1, wherein
the vibration analysis apparatus is implemented by application software that runs on a portable information terminal.

16. The vibration analysis system according to claim 15, wherein
the portable information terminal and the measurement instrument communicate with each other through wireless or wired communication.
